(19) United States
(12) Patent Application Publication
(10) Pub. No.: US 2007/0252919 A1
(43) Pub. Date: Nov. 1, 2007

(54) Remotely controlled adjustable flat panel display support system

(76) Inventor: Roy L. McGreevy, Sioux Falls, SD (US)

Correspondence Address: THOMTE LAW OFFICE, L.L.C., 2120 S. 72ND STREET, SUITE 1111, OMAHA, NE, 68124, US

(21) Appl. No.: 11/412,220

(22) Filed: Apr. 27, 2006

(51) Int. Cl. A47B 81/06; F16M 13/00; H04N 5/645

(52) U.S. Cl. 348/825; 312/7.2; 248/422

(57) ABSTRACT

A non or low intrusive support system for mounting a flat panel display device, which allows users to adjust the height and screen orientation to their preferred configuration, via a wireless remote control. The support device generally consisting of a stabilizing base, an extensible mast, an adjustable screen orientation apparatus and system for wireless control.

### FIELD OF THE INVENTION

The present invention relates in general to methods and apparatus for supporting a flat panel display device with the ability to adjust via a remote control device to viewing positions desired by the user.

### BACKGROUND

As the popularity of large flat panel display devices becomes more evident there is a need for more versatility in their installation, reconfiguration and method of use. The invention provides solutions for many of the problems encountered by the expanding market of flat panel display owners as well as adding versatility and convenience to the use of flat panel displays in the home and places of business.

One of the problems facing the users of flat panel displays is in their mounting. Many owners of flat panel displays do not have the option of mounting the display device to the wall or ceiling as they may live in an apartment or other residence wherein the walls may not be disturbed by mounting or hanging hardware robust enough to support a flat panel display device. Many flat panel displays are used in businesses where they need to be frequently moved from location to location which does not lend itself to the use of wall or ceiling mounts. Therefore what is needed is a freestanding support system that does not require modification of wall or ceiling surfaces to position a flat panel display device.

Another problem that faces flat panel display owners is the need to adjust the orientation of the display device to optimize the viewing experience. Most existing mounts for large flat panel display systems are limited to a single orientation of the display or to a position that is chosen from a limited range of orientations determined at the time of installation. Those mounting systems that do allow for some degree of adjustment usually require the user to physically re-orient the display to the desired position which is counter productive due to the fact that the user can not judge the orientation from their preferred position of viewing while having to be in physical contact with the display device to reorient the screen. The need for re-orientation is obvious considering the changes in the viewing environment, for example; a user may be watching the display device from a standing position wherein they might desire a relatively vertical tilt to the display while later on when reclining the user may desire the display to be tilted down to maintain the perpendicular relation between the users view and the display screen. Others may desire the screen tilted up or to the left or right to avoid the glare from light sources in the room. Some viewers may even desire to rotate the display at an angle so they can view the indicia on the screen in a correct relationship while reclining on their sides or even lying down. In a business setting it may be desirous to lift the display device to a significant height so that users can view what is on the screen over the heads of other viewers or over the tops of cubical walls. Therefore what is needed is a mounting device that can be adjusted in a variety of orientations to allow the user to view the screen according to their physical or personal preferences. Furthermore the means for adjustment should allow the user to remain in their viewing position while making the adjustments so that the desired orientation of the display device can be readily and conveniently achieved. Other considerations such as; ease of use, ease of assembly, shipping method, safety, and etcetera must also be considered in the display device mounting solution.

The inventor has devised the accompanying solution as no known, currently available solutions met the desired requirements. After a thorough search of the available solutions the closest known prior art did not provide the solutions that are needed within the industry. The following U.S. patents, known to the inventor, are insufficient to meet the need and therefore a new and innovative solution is disclosed herein.

U.S. Pat. No. 5,124,805, by Chung entitled, “Remote control operated moving television receiver” does not meet the need and is therefore distinct from the invention in that it relies on a display device, described as a CRT display, which is fully integrated into the adjusting apparatus. As the Chung solution does not anticipate the use of a flat panel displays or allows for the mounting of any of a variety of available display devices it does not meet the need. Because of this and the distinct differences in structure and function the inventor considers the Chung solution disparate from the present invention.

U.S. Pat. No. 6,095, 476 by Mathis entitled “Adjustable television stand” does not meet the need and is therefore distinct from the invention in that it is limed to utilizing an upper support top plate where upon is placed a television or CRT monitor. The present invention does not utilize a support surface for resting the display but rather relies on a mounting means that suspends a flat panel display device from its back, or other exterior surface, as is provided for in flat panel display device design. Because of this limitation and the distinct differences in structure and function the inventor considers the Mathis solution disparate from the present invention.

U.S. Pat. No. 6,149,253, by Talasani entitled “Video display positioning system” does not meet the need and is therefore distinct from the invention in that it is also limited to providing a platform and swiveling base onto which a display device is directly mounted. Because of this limitation and the distinct differences in structure and function the inventor considers the Talasani solution disparate from the present invention.

### SUMMARY

This attached specification teaches a system for mounting a flat panel display device in a manner in which the display screen supporting means is free standing and does not rely on support techniques requiring means intrusive to walls or ceilings. The apparatus of support includes a base and extensible mast and a universally adjustable mounting device coupled with remotely controlled actuating devices. Further more the invention teaches a mount that enables the display screen to be adjusted in a variety of orientations of adjustment such as; elevation, tilt, swivel and rotation. The adjustability of the system is controllable via a remote control device which allows the user to adjust the display device from the position of observation. The method of use and assembly is also taught within the specification and included in the claims.

### DESCRIPTION OF THE DRAWINGS

FIG. 1 is an isometric view of an embodiment of a flat panel support system representing the top, front and left sides.

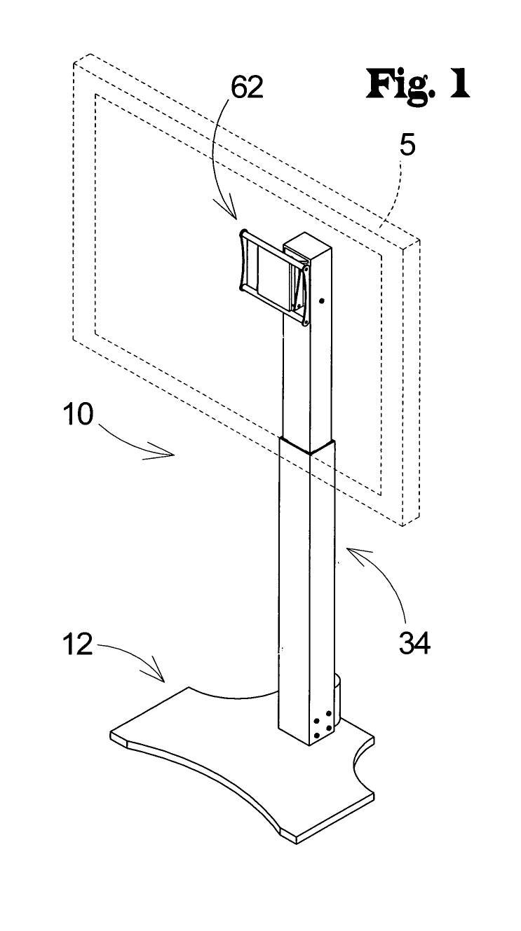

FIG. 2 is an isometric view of an embodiment of a flat panel support system representing the bottom, back and right sides.

FIG. 3 is an isometric view a flat panel support system representing the top, back and right sides demonstrating the extension and retraction of mast. A magnified view of the connection between the foundation column and extensible column included.

FIG. 4 is a cross sectional view of an embodiment of a flat panel support system.

FIG. 5 is an exploded view of the base of an embodiment of a flat panel support system demonstrating a potential structural configuration and constituent parts.

FIG. 6 is an exploded view of the mast of an embodiment of a flat panel support system utilizing a pair of rectangular shaped coaxially nesting columns.

FIG. 7 is a detail view of an embodiment of a manual adjustment control integrated into the foundation column.

FIG. 8 is a top view of an embodiment of a manual adjustment control integrated into the base.

FIG. 9 is a back view of a flat panel support device with magnifications of the base connector port and a top connector port.

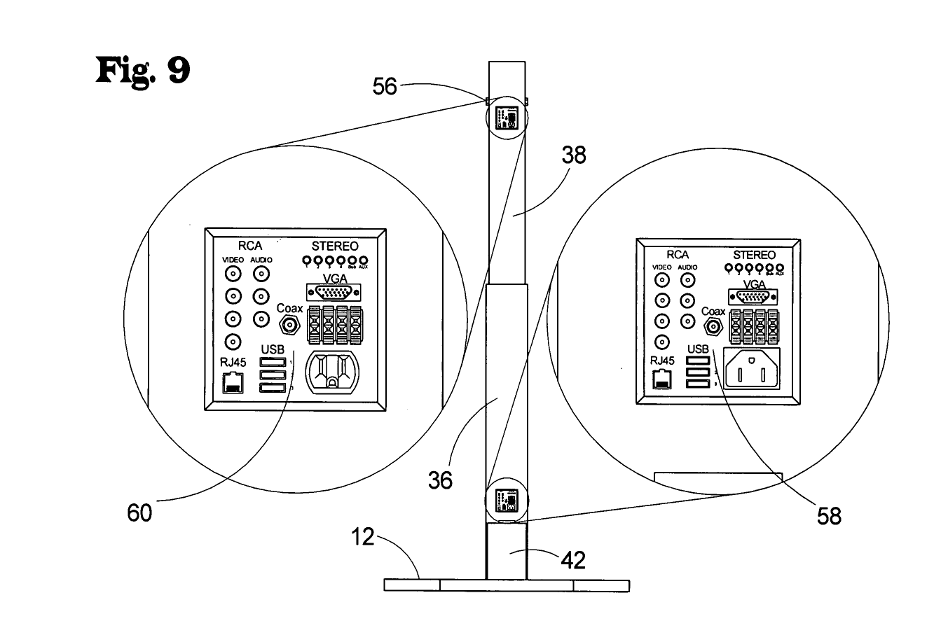

FIG. 10 is a cross sectional view with accompanying top side view of an embodiment of an orientation apparatus that of the present invention.

FIG. 11 is a cross sectional view with accompanying top side view of a second embodiment of an orientation apparatus different from that in FIG. 7;

FIG. 12 is an exploded view of an embodiment of an orientation apparatus.

FIG. 13 is a top view of an orientation apparatus that employs a swivel gear, swivel pinion and a rotary actuator.

FIG. 14 is an exploded view of the embodiment of an orientation apparatus generally related to FIG. 11.

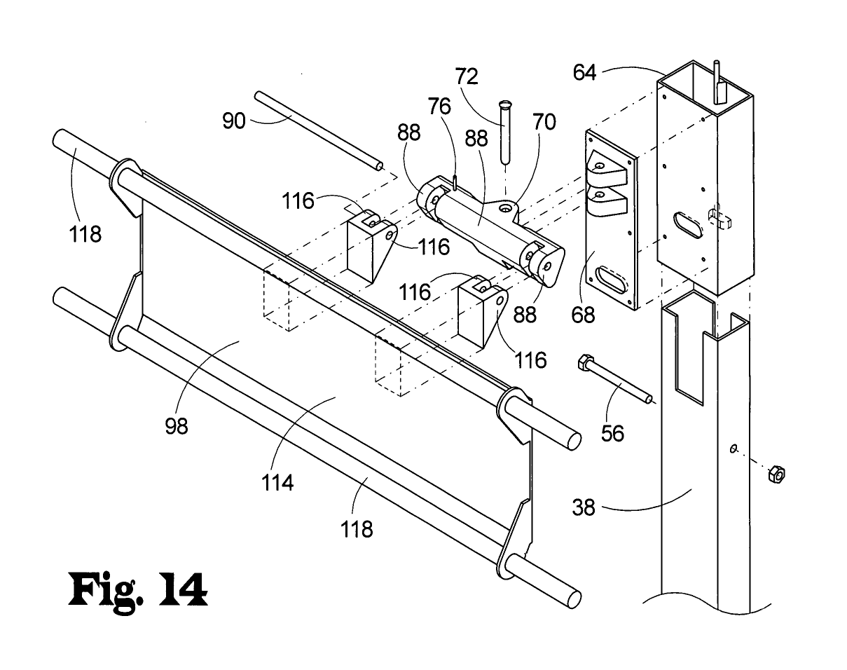

FIG. 15 is a schematic of a wireless control system having multiple receivers connected directly to the various actuators without a central actuator control device.

FIG. 16 is a schematic of a control system including a single receiver and an actuator control device wired to the various actuators.

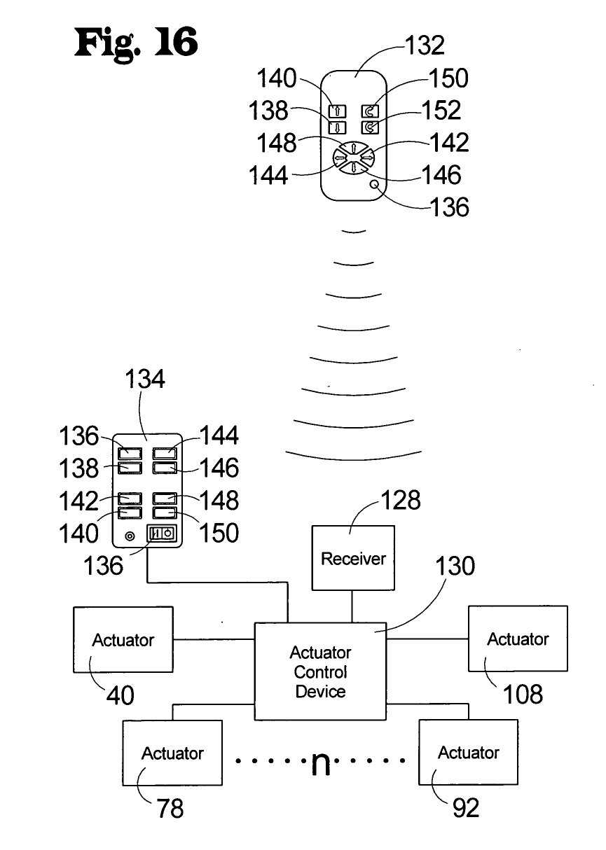

FIG. 17 is a profile view of a carriage device that may be employed to reposition or transport a flat panel support system.

FIG. 18 is an embodiment of a flat panel support device that employs a wall anchor and smaller base

FIG. 19 is an isometric view of a flat panel support system utilizing a console base and wheels.

### DETAILED DESCRIPTION OF THE PREFERRED EMBODIMENTS

In the following detailed description, reference is made to the accompanying drawings which form a part hereof, and in which is shown by way of illustration specific embodiments in which the invention may be practiced. These embodiments are described in detail sufficient to enable those skilled in the art to practice the invention, and it is to be understood that other embodiments may be utilized and that structural, logical and mechanical changes may be made without departing from the spirit and scope of the present invention. The following detailed description is, therefore, not to be taken in a limiting sense, and the scope of the present invention is defined by the appended claims.

The remotely controlled adjustable flat panel display support system (10) generally consist of a collection of major sub assemblies namely; the base (12), the mast (34), the orientation apparatus (62) and the control system (126). Each sub assembly has an assortment of elements that may constitute various embodiments that may or may not have impact on the structural or functional embodiments utilized in the other major sub assemblies.

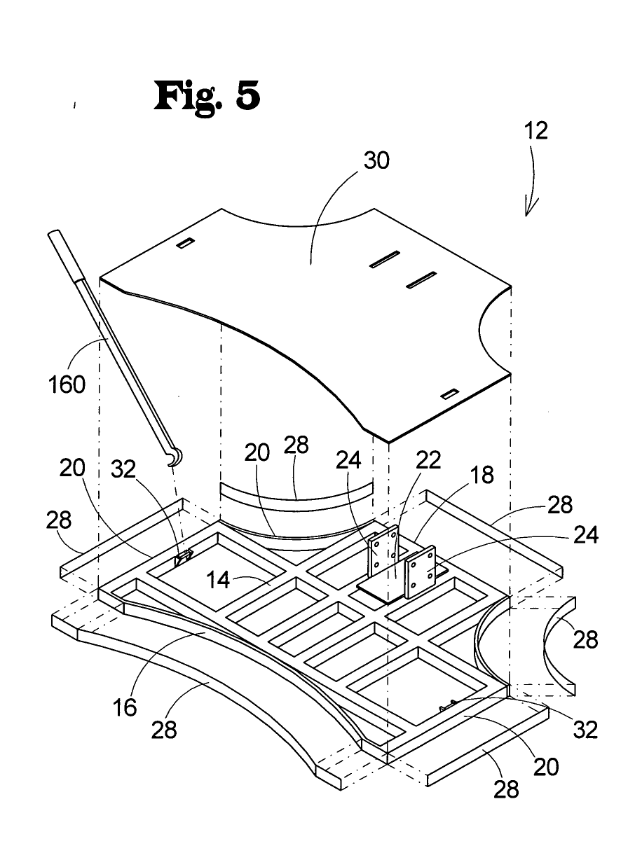

The constituent elements of the base (12) generally include a base frame (14) which provides a stable foundation on which the invention can function. The base frame may be comprised of a lattice of frame components as is demonstrated in FIG. 5. It may also be comprised of a solid mass of material or alternately by a boundary of rigid material forming the outer perimeter. The perimeter of the base (12) may be defined by the front base perimeter (16), the rear base perimeter (18) and a number of side base perimeter/s (20) that forms a shape capable of supporting the upper sections and the flat panel display device (5). The shape of the base (12) demonstrated in the accompanying drawings is but one embodiment that meets the requirements for bearing the upper structure and flat panel display device (5) and imparts a pleasing aesthetic appearance. The figures included herein are not meant to be limiting as many other shapes and forms are anticipated. For example round, oval or irregular shaped bases may be employed as long as the weight distribution and tilt stability are complimentary to the type of upper structure and type of flat panel display device (5) used.

The base (12) may include a support plate (22) located on the upper surface of the base frame (14) for supporting the mast actuator (40). The support plate may comprised a simple flat surface for bearing the weight of the upper assemblies and flat panel display device (5) or could include contouring for accepting and isolating the foot (44) of the mast actuator (40). In some embodiments the support plate (22) may include holes so that the mast actuator (40) may be accessed from the bottom of the base (12).

The base (12) may include a mast flange (24) for connecting the mast (34) to the base (12). In FIG. 5 the mast flange (24) consists of a pair of blades fixed to the base frame (14) that include holes that may be engaged with complimentary holes included in the foundation column (36). It is anticipated that the mast flange (24) may consist of alternate mechanical coupling schemes such as; a collection of flat or angled vertical tabs, a three or four sided sleeve, a number of connecting rods, screw mounted cylinder, etcetera.

On the bottom of the base (12) there may be mounted slide pads (26) that would facilitate the transport of the remotely controlled universally adjustable flat panel display support system (10) from one location to another. These slide pads are generally available on the market and are constructed of a durable plastic that has a low friction surface. Slide pads (26) allow easy moving of even heavy objects across a flat surface and take up only a fraction of the space required by casters or wheels. The slide pads (26) could be positioned on the bottom of the base (12) near the front (16) rear (18) and side (20) perimeters so that the weight of the invention and the flat panel display device (5) would bear on the slide pads (26) and not the base frame (14) facilitating convenient transport.

The exterior of the base (12) may include an aesthetically pleasing covering that may include perimeter trim (28) and/or base fascia (30). It is anticipated that the perimeter trim (28) and base fascia (30) could be made available in a variety of colors, textures and styles to accommodate the particular decor of the surrounding environment. The perimeter trim (28) would connect to the front (16) rear (18) and/or side (20) perimeters using a removable connection method such as; serrated pins, tension connectors, magnetic attraction, form fitting contouring, hook and loop materials such as Velcro, etcetera. The base fascia (30) may use similar methods of removably attaching to the base frame (14) and may include coupling devices mounted on the front (16) rear (18) and/or side (20) perimeters and/or the bottom of the base frame (14). The base fascia (30) may be designed to hold a piece of floor treatment such as carpeting, linoleum or even tile so that the base (12) conforms to the look of the surrounding floor. A template conforming to the shape required to envelope the base (12) would be provided so that the floor treatment could be cut to fit and then mounted on the base fascia (30) using adhesives or other connecting means. The base fascia (30) could then be mounted to the base (12).

The base (12) may also include a hitch connector (32) so that a draw arm (158) could be attached for convenient and safe transport of the remotely controlled universally adjustable flat panel display support system (10) and its accompanying flat panel display device (5). The purpose for the hitch connector (32) and draw arm (160) is to allow the user to remain upright while pulling on the base of the invention to move it. The use of this method of towing the invention would be preferable to pulling or pushing the remotely controlled universally adjustable flat panel display support system (10) by the mast or the flat panel display device.

To facilitate more efficient transport from one location to another the base (12) of the remotely controlled adjustable flat panel display support system (10) may include wheels (156) attached to the bottom of the base frame (14). Even if the base (12) does not include wheels a removable carriage apparatus (162) could be temporarily attached to the base (12) to facilitate a convenient means of moving the remotely controlled adjustable flat panel display support system (10). Wheel jack mechanisms (168) may also be integrated into the base frame (14) so that the wheels (156) may be retractable when the remotely controlled adjustable flat panel display support system (10) was not being transported. Wheels (156) could conform to various styles such as caster wheels, cylinder rollers, ball rollers, off centered bearing wheels and etcetera.

The mast (34) is the second major sub assembly of the remotely controlled universally adjustable flat panel display support system (10). The mast (34) performs the task of supporting and elevating the flat panel display device (5) to the desired height. The mast (34) includes a foundation column (36) that attaches to the mast flange (24) of the base (12). Positioned inside the foundation column (36) is the extensible column (38). The foundation column (36) and extensible column (38) may be in a nested or coaxial relationship so that they may slide along one another in a telescoping fashion but the invention is not so limited. It is anticipated that the axis of the extensible column (38) may be mounted parallel to the axis of the foundation column (36) without necessarily being coaxial to one another. It is further anticipated that the invention could include a plurality of extensible columns (38) mounted within the foundation column (36). The cross-sectional shape of the foundation column (36) and extensible column (38) are demonstrated in the accompanying drawings as nested rectangular forms but the invention anticipates that a wide variety of closed and open shapes could be employed in the construction of the foundation column (36) and extensible column (38). It is also true that the foundation column (36) and extensible column (38) are not required to be of the same cross-sectional shape as long as the extensible column (38) could extend and retract within the foundation column (36).

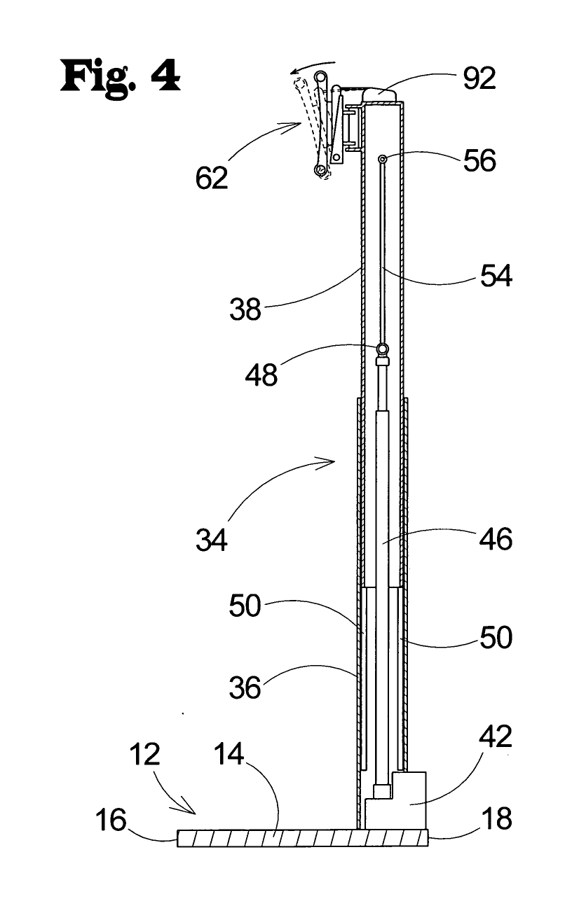

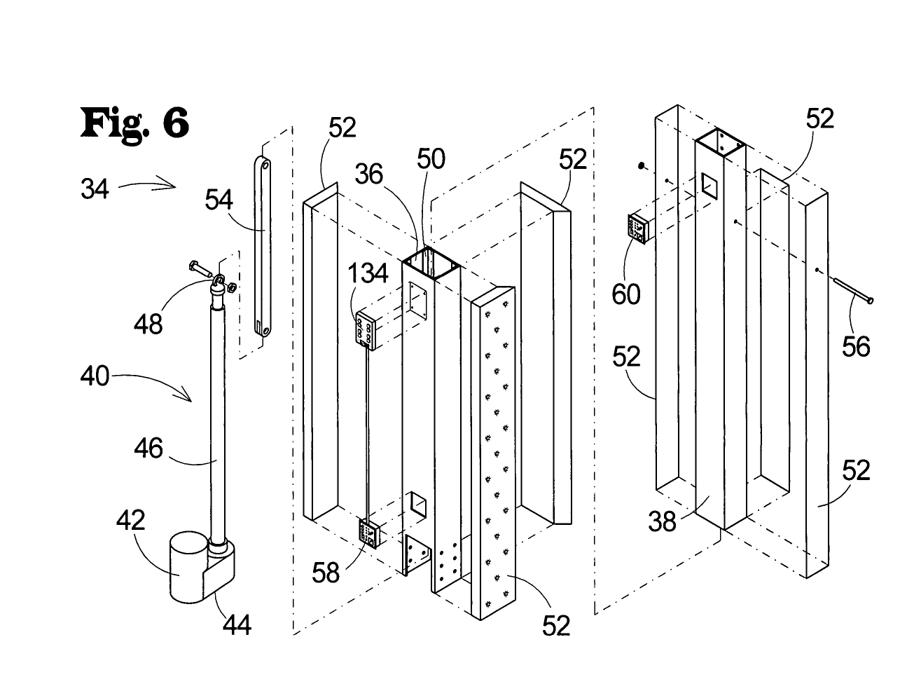

Generally within the interior of the foundation column is the mast actuator (40). The mast actuator (40) is the active mechanism for extending or retracting the extensible column (38) which raises or lowers the flat panel display device (5). The mast actuator (40) demonstrated in FIGS. 4 and 6 is a standard linear actuator which is commonly available on the market. The mast actuator is positioned between the base and a connection point on the extensible column (38) so that it may support the extensible column and elements there attached including the orientation assembly (62) and the flat panel display device (5). In the illustrated embodiments the mast actuator (40) is the main load bearing support and the foundation column (36) only isolates and guides the extensible column (38) as it extends or retracts in a telescopic fashion. In an alternate embodiment the mast actuator (40) may be a rotary actuator that is mounted within either the foundation column (36) or the extensible column (38) and engages its respective column via a high torque gearing system such as a worm gear whereby the columns bear on one another to support the flat panel display device (5). Another alternate embodiment of the mast actuator (40) would be a rotary actuator coupled to a wench so that a cable attached to a pulley mounted near the top of the foundation column (36) and attached near the bottom of the extensible column (38) could extend or retract the extensible column by drawing in or letting out cable. The use of counter weighted or gas cylinders, as is utilized in studio camera pedestals, to reduce the amount of work required by the mast actuator (40) are also anticipated within the scope of the invention.

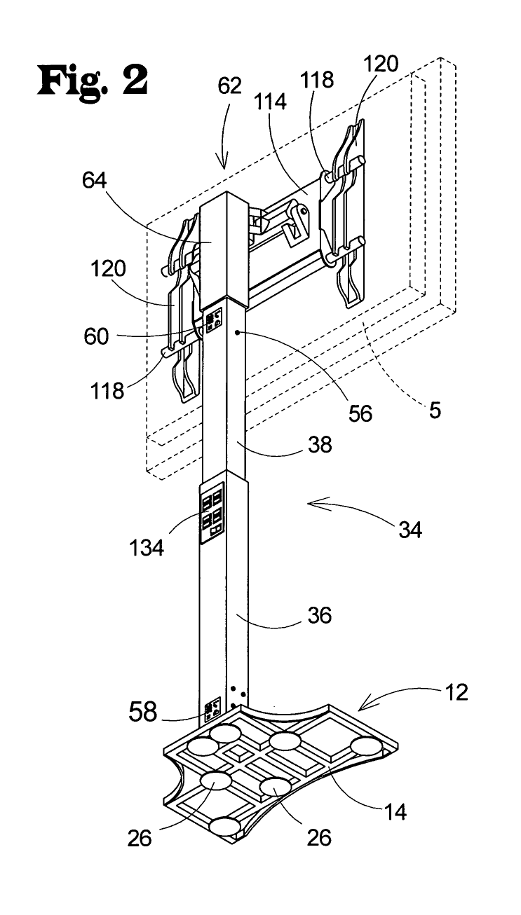

The mast actuator (40) as depicted in the accompanying drawings consists of a motor (42), a foot (44), a telescoping arm (46) and a ring (48). The motor (42 of the mast actuator (40) powers the extension and retraction of the telescoping arm (46). In FIG. 2 the motor (42) is shown generally outside of the foundation column (36) on the back side of the base (12). In other embodiments the entire mast actuator may be located outside of the foundation column (36) and attached to the extensible column on its rear exterior surface. The invention also anticipates that the entire mast actuator (40) including the motor (42) may be totally enclosed within the foundation (36 or extensible (38) columns. The foot (44) of the mast actuator (40) is the bottom surface of the actuator that supports the weight of the upper assembly, the flat panel display device (5) and the mast actuator (40) itself. The foot (44) is supported on the support plate (22) of the base (12). The telescoping arm (46) is the element responsible for extending and retracting the extensible column (38) of the mast (34). Increasing or decreasing the distance between the support plate (22) and the cross bolt (56) that is connected to the extensible column (38). The ring (48) is mounted on top the telescoping arm (46) to permit the attachment of the cross bolt (56) or extension arm (54).

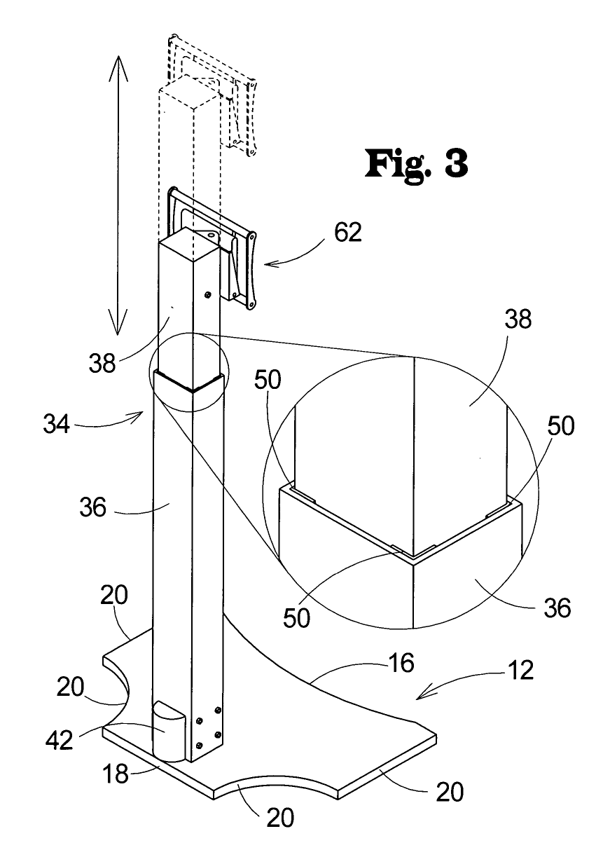

Located in-between the foundation column (36) and the extensible column (38) one or more low friction guide (50) may be included to assure smooth extension and retraction of the extensible column into and out of the foundation column (36). The low friction guides (50) as depicted in FIG. 3 and FIG. 4 are mounted within the interior corners of the foundation column so that the low friction guides (50) contact the extensible column (38) about its exterior corners thereby isolating any play between the foundation column (36) and extensible column (38) and reducing friction and noise when the mast (34) is in motion. The low friction guides (50) may alternately be mounted on the exterior surface of the extensible column (38) to produce the same effect. The low friction guides (50) depicted in the drawings are in the form of angled strips but the invention is not so limited, as the low friction guide (50) may take the form of a sleeve encompassing the entire foundation (36) and/or extensible (38) columns. Likewise the low friction guide may take the form of a plurality of distributed patches placed between the foundation column (36) and/or the extensible column (38) to assure proper buffering and ease of movement.

Like the base (12) the mast (34) would include the capability to accept an aesthetically pleasing facade so that it may better blend into the ambient environment. A mast veneer (52) would comprise a thin plate, sheet or membrane that would be connected to the exterior surfaces of the foundation column (36) and/or the extensible column (38). The mast veneer joined to the extensible column (38) may comprise a colored or textured material that also comprises the low friction guide (50) so that the two elements are combined into a single element. The mast veneer may be applied to the foundation column (36) and/or the extensible column (38) using a variety of methods including but not limited to adhesives, serrated pins, tension connectors, magnetic attraction, form fitting contouring or hook and loop materials such as Velcro. The mast veneer may cover the entirety of either column (36, 38) or may be limited to selected areas. The size and shape of the mast veneer (52) mounted to the foundation column (36) is not limited by the cross-sectional shape of the of the foundation column. For example, if the foundation column was rectangular the mast veneer (52) could be circular, oval, or have an irregular shape. The mast veneer (52) mounted to the foundation column (36) could also resemble other objects such as the trunk of a tree or plant, the padding traditionally found at the base of football goal posts, etcetera. In FIG. 6 the mast veneer (52) of the foundation column (36) consists of three separate pieces of padded upholstery that not only attach to the foundation column (36) but also connect to one another. The mast veneer (52) of the foundation column may also include functional elements such as small shelves, CD disc holding flanges, pockets, mounting connectors for speakers or subwoofers, etcetera.

Between the ring (48) of the mast actuator (40) and the cross bolt (56) it may be beneficial to utilize an extension arm (54) so that the cross bolt (56) can be mounted higher in the extensible column when the telescoping arm (46) of the mast actuator (40) is in a fully retracted position.

The cross bolt (56) would provide a load bearing member directing the weight of the extensible column (38), the orientation apparatus (62) and the flat panel display device (5) to the base (12). The cross bolt (56) in the accompanying illustrations is depicted as a rigid steel rod spanning from one side of the extensible column (38) to the other side. Alternately the cross bolt could comprise a rigid connection to one or more interior surfaces of the extensible column (38) or even an exterior surface of the extensible column (38). Depending on where the cross bolt (56) is mounted within the extensible column (38) it may be necessary to inset the bolt head and/or nut of the cross bolt so that the section of extensible column that it is attached to can retract into the foundation column (36). It is anticipated that the nut portion of a cross bolt could be integrated into the extensible column (38) itself by taping the respective hole.

In FIG. 2 the mast (34) is depicted as having a manual adjustment control (134) on the upper rear portion of the foundation column (36). Placement of a manual control (134) is in anticipation of a user wishing to adjust the flat panel display device (5) without the use of a remote control device (130). The placement of the manual adjustment control (134) on the rear of the foundation column would allow easy access to the manual adjustment control (134) without disrupting the aesthetic of the remotely controlled universally adjustable flat panel display support system (10). Also in FIG. 2 a base connector port (58) is located near the bottom of the foundation column (36) and a top connector port (60) is located near the top of the extensible column (38). These may be mounted on the rear of the mast (34) for the same aesthetic reasons as the manual adjustment control (134) but may also have the functional advantage of eliminating distracting and/or dangerous cables hanging directly from the flat panel display device (5). This method of cable management would eliminate unsightly pendulous power and signal conducting cables by enclosing them within the mast (34). The base (58) and top (60) connector ports would be in electrical communication with one another via cables designed to move within an extendable conduit such as bias coiled wires similar to those used ubiquitously in telephone handsets, looped flat cables as are generally used in industrial automated machines or even sliding sets of conductors.

The orientation apparatus (62) supports the flat panel display device (5) via a connection to the flat panel display device (5) on the back side or side opposite to the viewing screen and facilitates the adjustment of the flat panel display device (5) in a wide range of positions. In the various embodiments the orientation apparatus (62) is mounted to the extensible column (38) in various fashions. Illustrated in FIG. 4 the first swivel axel hinge knuckles (70) are incorporated into the structure of the top of the extensible column (38) in that the knuckles of the swivel hinge (66) are an inbuilt part of the extensible column (38).

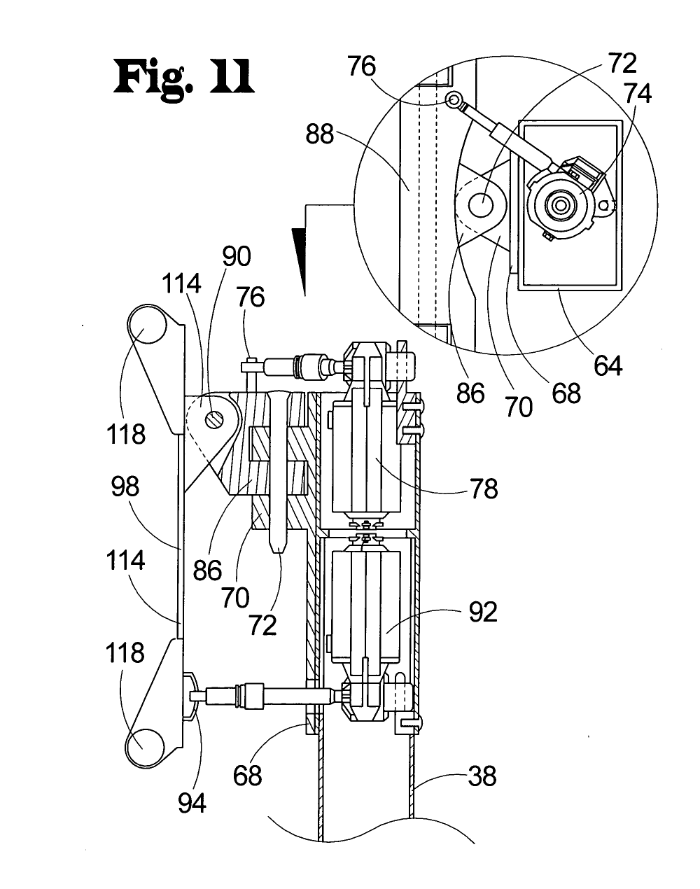

In FIG. 6 the extensible column included bolt holes so that the swivel hinge (66) could be bolted onto the extensible column through the agency of a connector plate (68) as is depicted in FIG. 11. The connector plate (68) consists of a flat plate that includes means for connection to the extensible column (38). In several embodiments of the invention the connector plate (68) and the first swivel hinge knuckles (70) are combined into a single unit. In other embodiment such as the cupola (64) or a single rotating bayonet connection the connector plate is unnecessary for supporting the orientation apparatus.

In FIG. 2 the orientation assembly (62) is mounted on the extensible column (38) using a cupola (64) that envelops the top section of the extensible column (38). The cupola (64) is comprised of a rigid sleeve conforming to the shape of the upper section of the extensible column (38). At some point along the inside of the cupola there is a means for limiting the penetration of the extensible column (38) within the cupola. In some cases the inhibiting mechanism may be in the form of a closed end of the sleeve, or a wall dividing the cupola into two separate cavities, in other cases the means for penetration inhibition may comprise a fixed ridge or limiting blocks only large enough to inhibit the penetration of the extensible column. In some embodiments of the cupola (64) the first swivel axel hinge knuckles (70) are integral to the cupola (64), in other embodiments the swivel hinge (66) may be attached to the cupola (64) via a connector plate (68). Many other methods may be employed in fixing the orientation apparatus (62) to the mast (34) such as hook connectors, bayonet mounts, latch connectors, tension bands, slot connecters, etcetera.

The range of adjustability provided by the orientation apparatus (62) may be separated into three distinct types of motion; swiveling, tilting and rotating. Swiveling occurs when the flat panel display device (5) turns on a vertical axis perpendicular to the floor (1). Tilting occurs when the flat panel display device (5) turns on a vertical axis parallel to the screen of the flat panel display device (5). Rotation occurs when the flat panel display device (5) turns on a vertical axis perpendicular to and running through the screen of the flat panel display device (5).

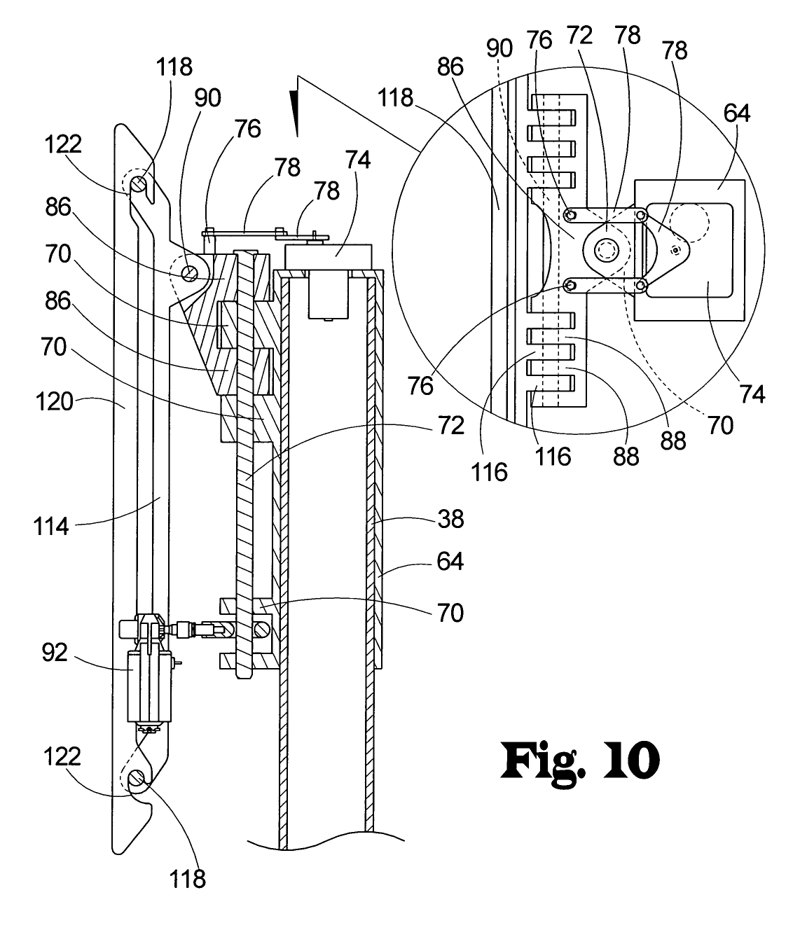

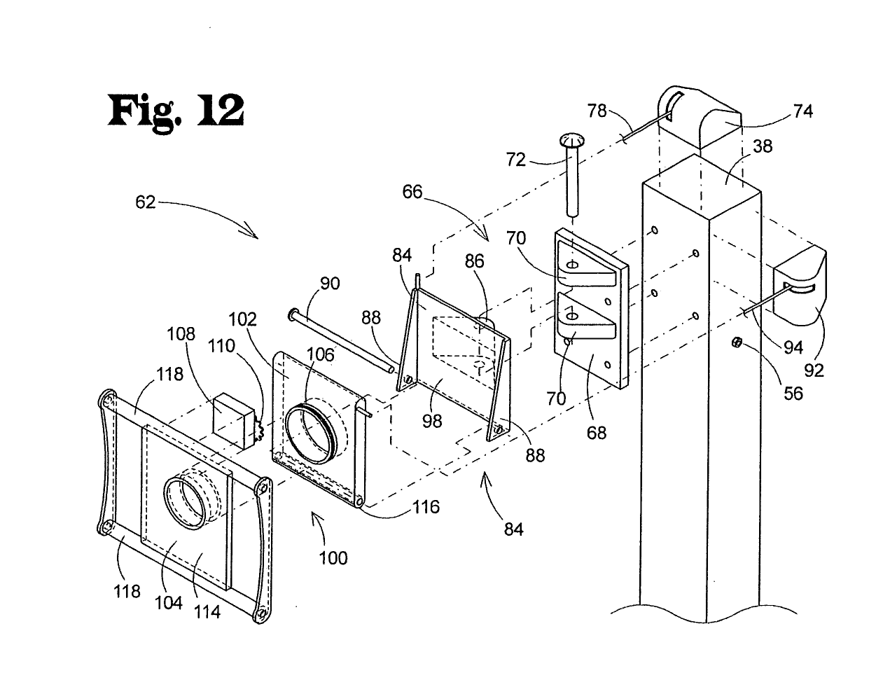

The group of elements that facilitate the swivel function of the orientation apparatus is collectively referred to as the swivel hinge (66). The swivel hinge (66) may comprise two or more of the following elements; one or more first swivel axel hinge knuckles (70), swivel hinge pin (72), swivel actuator (74), one or more swivel bars (76), one or more swivel articulators (78), swivel gear (80), swivel pinion (82), one or more second swivel axel hinge knuckles (86). The weight bearing members of the swivel hinge (66) include the first swivel axel hinge knuckles (70) that mount on or to the mast (34) side of the swivel hinge (66) and the second swivel axel knuckles (86) mounted to the flat panel display device (5) side of the swivel hinge (66). These two elements are interlocked by the swivel hinge pin (72). The number of knuckles included in either the first swivel axel hinge knuckles (70) or the second swivel axel knuckles (86) is determined by the size of the knuckles and the material of which they are composed as is well known in the industry. In FIG. 4 there are a pair of first swivel axel hinge knuckles (70) that are integrated into the extensible column but only a single second swivel axel hinge knuckle (86) that is in the shape of a cylinder that the swivel pin (72) passes through. In FIGS. 10 and 11 the first (70) and second (86) swivel axel hinge knuckles each include two knuckles. FIG. 12 demonstrates two knuckles employed in the first swivel axel hinge knuckles (70) integrated into a connector plate (68) and one knuckle employed in the second swivel axel hinge knuckles (86) connected to the tilt assembly (84)

The swivel actuator (74) is the mechanism that changes the position of the orientation apparatus (62) in its swiveling motion. The actuator itself may consist of a wide variety of actuator types such as linear actuators, rotary actuators, magnetic solenoids, bipolar stepper motors, pneumatic actuators, hydraulic cylinders, and etcetera. The swivel actuator (74) acts on elements of the orientation apparatus (62) on either side of the swivel hinge (66) or swivel hinge pin (72).

In FIG. 11 the swivel actuator (74) is a linear actuator which is mounted inside the cupola (64) on a pin fixed to the interior of the cupola, on which it can rotate. The pushing arm of the swivel actuator (74) is attached to a swivel bar (76) that is located at the top of the tilt assembly (84) to the right side. In practice, extending the arm of the swivel actuator (74) would push the right side of the tilt assembly farther away from the mast (34) and therefore swiveling the flat panel display device (5) to the left. Similarly contracting the arm of the swivel actuator (74) would draw the right side of the tilt assembly (84) towards the mast (34) therefore swiveling the flat panel display device (5) to the right.

In FIG. 10 the swivel actuator (74) is a rotary actuator which is mounted to the top of the cupola (64) with the gear box generally above the top level of the cupola (64) and the motor generally below the level of the cupola (64). On the tilt assembly (84) there are mounted two swivel bars (76) mounted equidistantly to the right and left of the tilt assembly (84). In between the rotary swivel actuator (74) and the swivel bars (76) are swivel articulators (78) that transmit the action of the swivel actuator (74) to the swivel bars (76). In the case of FIG. 11 the swivel articulators (78) consist of a yoke mounted to the rotating axel of the swivel actuator (74) and two linear connecting rods that connect the swivel bars to the horns of the yoke. Swivel articulators (78) may take on many shapes and forms, such as push arms, levers, control lines, scissor mechanisms, cams, wedges, gears, pinions, worm gears and etcetera which are commonly employed and generally known by those of skill in the art. The swivel articulator's function is to transmit the motion of the swivel bar (76) to an element of the orientation apparatus (62) on the opposite side of the swivel hinge (66) to which the swivel actuator (74) is mounted.

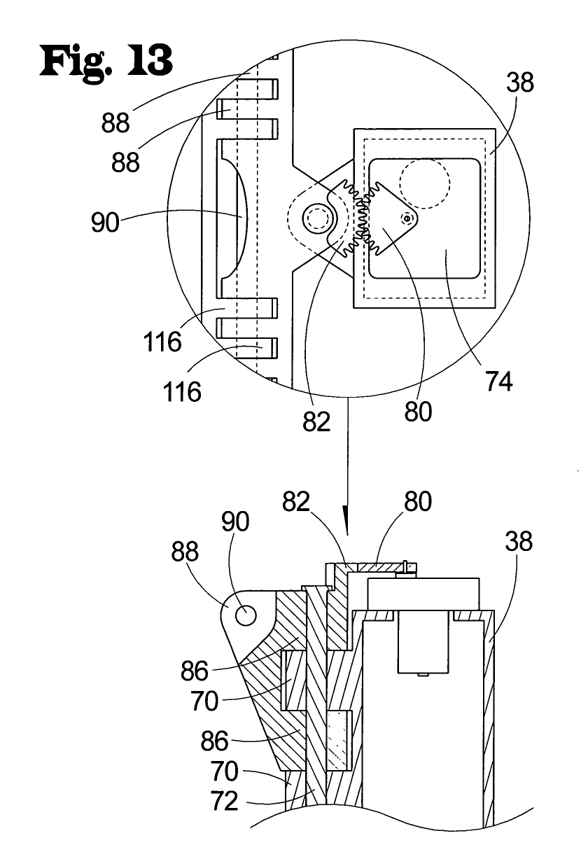

The swivel articulators (78) illustrated in FIG. 13 for example are in the form of a swivel gear (80) and a swivel pinion (82). The swivel gear is depicted as being mounted to the rotary axel of a rotary swivel actuator (74). The cogs of the swivel gear (80) are meshing with the cogs of the swivel pinion (82) in full mechanical communication. The figure depicts the swivel pinion (82) as being integrated into the second swivel axel knuckle (86) but the swivel pinion (82) could alternately be a separate piece mounted to the second swivel axel knuckle (86) or a correctly placed swivel bar/s (76).

The group of elements that facilitate the tilt function of the orientation apparatus is collectively referred to as the tilt assembly (84). The tilt assembly (84) may comprise two or more of the following elements; one or more first tilt axel hinge finger (88), a tilt hinge pin (90), tilt actuator (74), one or more tilt articulators (94), and one or more second tilt axel hinge knuckles (86). The weight bearing members of the tilt assembly (84) include the first tilt axel hinge knuckles (88) that are connected to the second swivel axel hinge knuckles on the mast (34) side of the tilt assembly (84) and the second tilt axel knuckles (116) mounted to the flat panel display device (5) side of the tilt assembly (84). These two elements are interlocked by the tilt hinge pin (90). The number of knuckles included in either the first tilt axel hinge knuckles (88) or the second tilt axel knuckles (116) is determined by the size of the knuckles and the material of which they are composed.

In FIG. 10, there are 8 first tilt axel hinge knuckles that are combined to the second swivel axel hinge knuckles in a single piece. Six second tilt axel hinge knuckles (116) are joined to the first tilt axel hinge knuckles (88) via the tilt hinge pin (90).

In FIG. 12 the first tilt axel hinge knuckles (88) consist of two knuckles located on the end of a plate to which the second swivel axel hinge knuckles are attached on the opposite side. The second tilt axel hinge knuckle (116) includes a single knuckle that comprises the bottom portion of the tilt plate (98).

The tilt actuator (92) is the mechanism that changes the position of the orientation apparatus (62) in its tilting motion. The actuator itself may consist of a wide variety of actuator types such as linear actuators, rotary actuators, magnetic solenoids, bipolar stepper motors, pneumatic actuators, hydraulic cylinders, and etcetera. The tilt actuator (92) acts on elements of the orientation apparatus (62) on either side of the tilt assembly (84) or tilt hinge pin (90).

In FIG. 10 the tilt actuator (92) is a linear actuator that is mounted on the tilt plate (98). The end of the linear tilt actuator (92) arm is hingedly attached to the swivel hinge pin (72) by means of a tilt articulator (94) that takes the form of a ring that can float within the gap formed between two first swivel axel hinge knuckles (70). In practice, when the tilt actuator (92) is extended, the bottom of the tilt plate (98) would move away from the mast (34) thus tilting the flat panel display device (5) upward. Conversely, when the tilt actuator (92) is retracted, the bottom of the tilt plate (98) would move towards the mast (34) thus tilting the flat panel display device (5) downward.

In FIG. 11 the tilt actuator (92) is again a linear actuator that is located within both the cupola (64) and the extensible column (38) so that extendable arm extends out near the bottom of the cupola (64). The tilt actuator is mounted on a pin that is fixed to the interior surface of the cupola (64) so that the tilt actuator (92) can turn in an arc with the flat panel device (5). The arm of the tilt actuator (92) is connected to the tilt plate (98) through the agency of a tilt articulator (94). In FIG. 11 the tilt articulator takes the form of a curved rail that would allow the end of the tilt actuator arm to slide up and down its length as the tilt panel tilted out and back. Other forms of tilt articulators would be obvious to those skilled in the art and may include a tethered bumper, a sliding ball joint, a low friction carriage connecter and etcetera.

The tilt plate 98 is the element that is either attached to or that includes the second tilt axel hinge knuckle (116) and actually moves in a tilting motion. In some embodiments the tilt plate (98) is synonymous with the mounting plate (114) in that there is no rotation assembly (100). In other embodiments the tilt plate is the element that carries the rotation assembly (100)

The group of elements that facilitate the rotation function of the orientation apparatus is collectively referred to as the rotation assembly (100). The rotation assembly (100) may comprise two or more of the following elements; a rotation plate (102), an axel plate (104), a rotation axel (106) a rotation actuator (107) and a rotation articulator (108). The weight bearing members of the rotation assembly (100) include the rotation plate (102) that may be connected to or integrated with the tilt plate (98) on the mast (34) side of the rotation assembly (100) and the axel plate (104) mounted to the flat panel display device (5) side of the rotation assembly (100). These two elements are axially joined by the rotation axel (106).

In FIG. 12 the rotation plate (102) is integrated with the tilt plate (98) such as the two elements are a single unit. In the center of the rotation plate (102) is the outer ring of the rotation axel (106). The axel plate (106) like wise is integrated with the mounting apparatus (112) comprising a single unit. Mounted to the center of the axel plate (104 is the inner ring of the rotation axel (106). In FIG. 12 the rotation axel (106) is a hubless axel that employs roller bearings, ball bearings or low friction skids and is designed to support a significant amount of weight but the invention is not so limited. The rotation axel (106) may be a more common axel employing a solid shaft or a combination of smaller planetary wheels or gears engaging a single ring. Various methods of rotational mounting not cited herein will be evident to those skilled in the art.

A rotation actuator (108) may be any type of actuator device as mentioned above and may be mounted to either the rotation plate (102) or the axel plate (104). If the rotation actuator (108) is mounted on the rotation plate (102) the active element of the rotation actuator (108) may act upon an element of the orientation apparatus (62) on the flat panel display side; such as the rotation axel (106), the axel plate (104) and/or mounting plate (114). Conversely if the rotation actuator (108) is mounted on the axel plate (104) the active element of the rotation actuator (108) may act upon an element of the orientation apparatus (62) on the mast (34) side such as; the rotation plate (102) and/or an element of the tilt assembly (84) or an element of the swivel hinge (66).

In FIG. 12 the rotation actuator (108) is mounted to the axel plate (104) so that a rotation articulator (110) in the form of a toothed gear can engage gearing mounted on the outer rim of the rotation axel (106). Using FIG. 12 as an example an alternate embodiment may have the rotation actuator (108) mounted to the rotation plate (102) inside the ring of the rotation axel (106). The rotation actuator (108) in this instance may be a rotary actuator and the rotation articulator (108) may be in the form of a set of spokes connecting the rotating shaft of the rotation actuator (108) to the inner ring of the rotation axel. Yet another embodiment may have the rotation actuator (108) in the form of a worm gear actuator mounted to the axel plate (104) wherein the grooves of the worm gear would engage the rotation articulator (110), in the form of a toothed gear mounted around the perimeter of the outer ring of the rotation axel (106).

The mounting plate (114) is of a design frequently used for mounting flat panel display devices (5) to walls. The support rods (118) that are fixed to the mounting plate (114) are designed to connect to a number of rod hooks (122) integrated into a pair of panel bearing struts (120). The flat panel display device (5) is directly connected to the panel bearing struts (120) with nuts, bolts, screws, prongs and etcetera via the mounting slot (124) located in the trough of the panel bearing struts (120). The flat panel display device (5) thus connected to a pair of panel bearing struts (120) may them be hung from the support rods (118) by engaging the support rods (118) into the rod hooks (122) of the panel bearing struts (120) Methods of locking or removably fixing the panel bearing struts (120) to the support rods may include limiting bolts, tension screws, latches, inhibiting blocks, and etcetera, so that the flat panel display device (5) remains mounted during orientation motion.

FIG. 2 illustrates the relationship of the mounting plate (114) and support rods (118) engaged to the panel bearing struts (120) through the agency of the rod hooks (122). As this method of mounting is currently employed and well known in the industry it is assumed that its practice is known to those skilled in the art.

The control system (126) may include such elements as one or more wireless receivers (128), one or more actuator control devices (130) any number of remote control devices (132) any number of manual adjustment control devices (134). The purpose of the control system is to operate the various actuators (40, 74, 92 & 108) to position the screen of the flat panel display device (5) in the orientation desired by the user. The remote control device (132) may communicate signals to the wireless receivers (128) using signaling methods available in the electromagnetic spectrum. Such methods may range from low frequency audio signals to microwave signaling techniques with the preferred ranges being within the infrared frequencies or radio frequencies. Remote control devises (132) using such signaling methods are well known in the industry and will not be specifically defined herein. It is anticipated that standard programmable, multi device or learning remote control devices (132) currently in use by the general public could be utilized to control the actuators (40, 74, 92 and/or 108) through the use of general purpose signaling codes.

The remote control device (132) may include activation controls such as buttons, switches, toggles, knobs, foot pedals, levers, touch screen pressure sensors, inductive touch sensors, voice recognition devices and etcetera allow the user to input instructions. When these controls are activated the remote control device may transmit a signal specific to the specific control activated that would in turn be received by a wireless receiver (128). Having received the signal the wireless receiver (128) would communicate the signal to the actuator control device (130) which would then activate the actuator (40, 74, 92 or 108) in the correct manner, to move the flat panel display device (5) in the direction specified by the signal received.

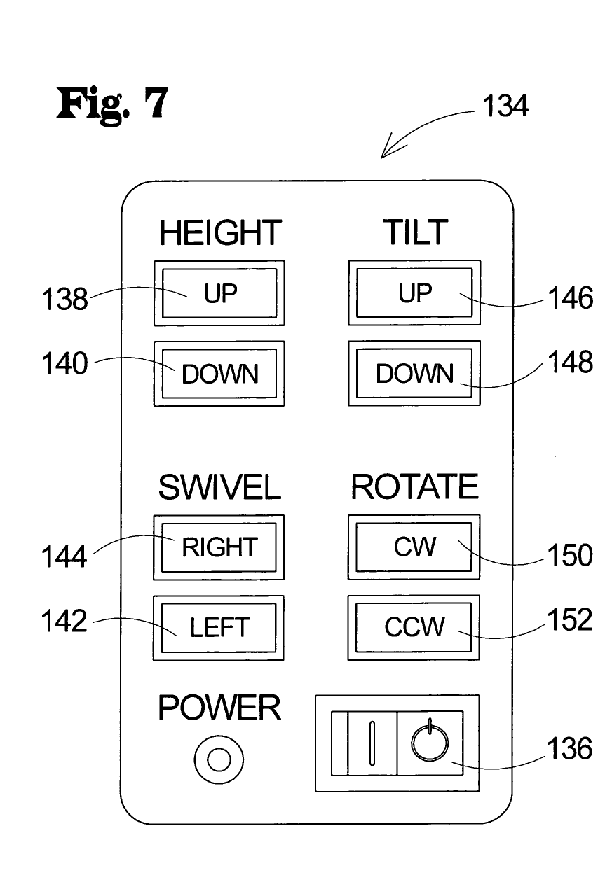

FIG. 7 illustrates a manual adjustment control (134) that includes controls to adjust the orientation and height of the flat panel display device (5) which include; a power switch (136), an extend mast control (138), a retract mast control (140), a swivel left control (142), a swivel right control (144), a tilt up control (146), a tilt down control (148), a rotate clockwise control (150) and a rotate counter-clockwise control (152). The remote control device may include the same set of controls (136-152)

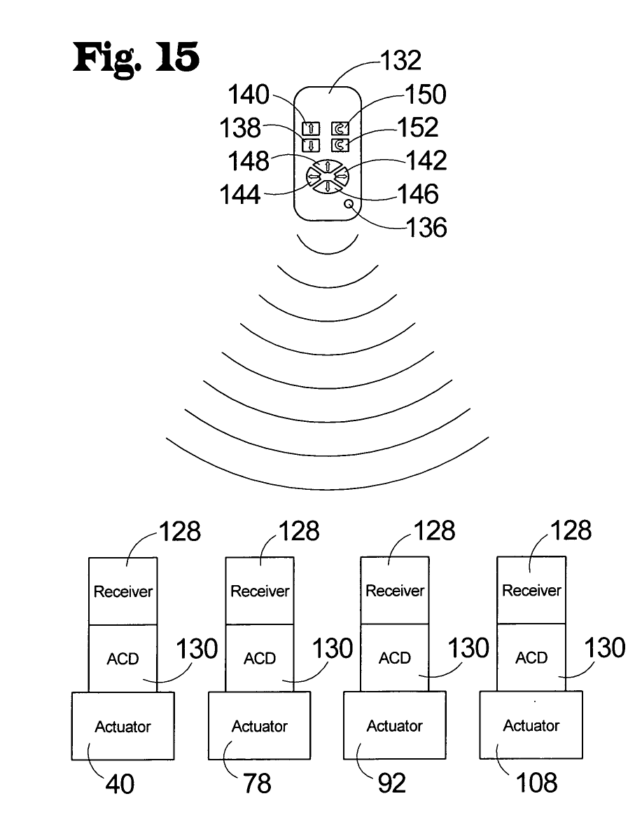

FIG. 15 depicts an embodiment of the control system (126) architecture wherein the remote control device (130) sends a signal to a plurality of wireless receivers (128) that are directly attached to an actuator control device (130) that may be as simple as a single switch. The actuator control device (130) is also directly attached to the actuator itself so that each actuator (40, 78, 92 & 108) work completely independent of one another.

FIG. 15 depicts an embodiment of the control system (126) architecture wherein the remote control device (130) sends a signal to a wireless receiver (128) that is communicatively linked to the a central actuator control device (130) that may include a microprocessor. The actuator control device (130) is linked to the various actuators via electrical signal conductors. It is anticipated that the actuators (40, 78, 92 & 108) may include sensors to relay the position of the actuator or element of the orientation apparatus (62) or likewise the extension of the mast (34) thereby creating a two way communication with a central microprocessor that might include a memory to store programming to adjust the flat panel display device into preset configurations which may be recalled and adjusted with the activation of certain controls.

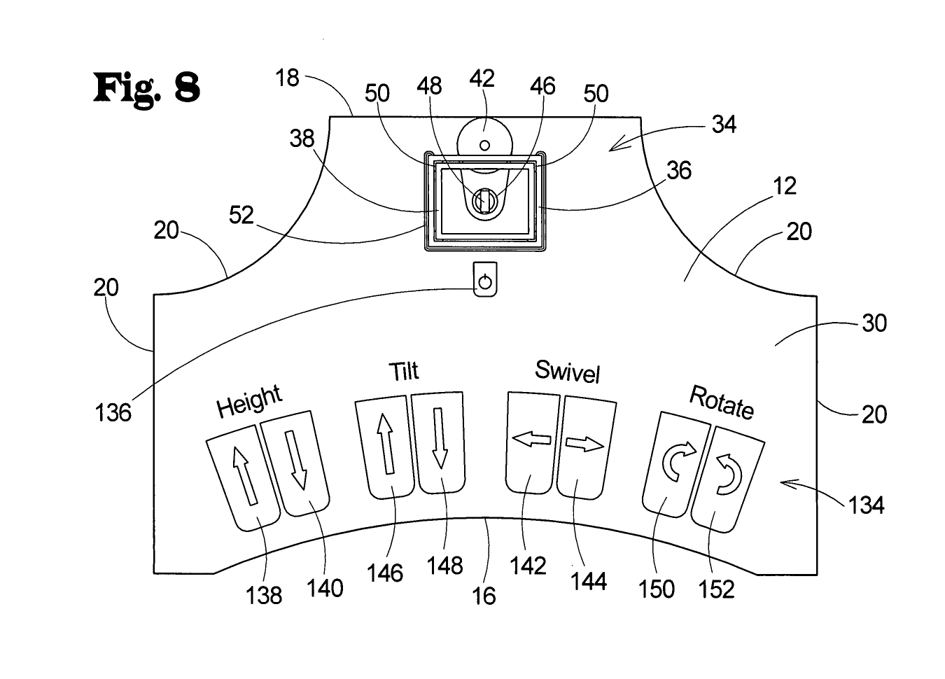

Similar to the remote control device (132) the manual adjustment control (134) may contain similar controls but would be directly wired to the central actuator control device (130) and made available either mounted on the remotely controlled adjustable flat panel support system (10) or in an area from which it would be convenient to control the remotely controlled adjustable flat panel support system (10). FIG. 8 demonstrates a manual adjustment control (134) that is integrated into the base (12). The controls in this example are in the form of foot pedals and the user may adjust the orientation and height of the flat panel display device by stepping on the control desired. It may be desirous to locate a manual adjustment control (134) on the screen side of the flat panel display device (5). A manual adjustment control (134) may easily be mounted to the screen side of the flat panel display device (5) in the form of a tethered dongle wherein the tether cord would include the electrical signal conductors.

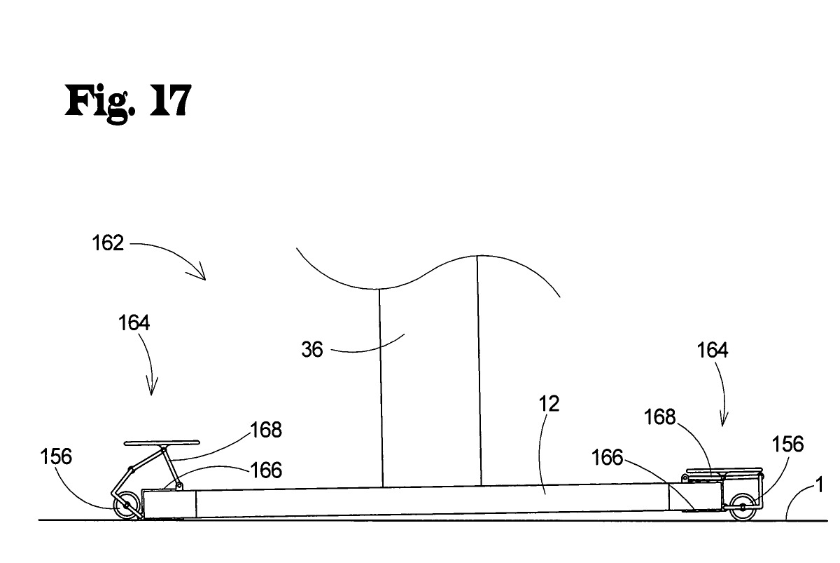

In FIG. 17 the remotely controlled adjustable flat panel display support system (10) is in the process of being lifted by a carriage apparatus (162). The carriage apparatus (162) in the illustrated embodiment includes at least two wheel units (164), one mounted on the right side of the base (12) and another mounted on the left side of the base (12). Each wheel unit (164) may consist of a base clamp (166), at least one wheel (156) and a wheel jack mechanism (168). The carriage apparatus (162) is operated by first engaging the base clamp (166) onto the side base perimeter (20). The base clamp (166) may engage the base (12) through a multitude of means including tension, gravity, spring bias, or various connecting devices. In FIG. 17 the base clamp (166) is held in place by tension. The wheel jack mechanism (168) may then be utilized to lift the base (12) and position the wheel (156) to take the load of the remotely controlled adjustable flat panel display support system (10). The wheel jack mechanism (168) in the embodiment illustrated in FIG. 17 is comprised of a series articulated arms and joints that when compressed beneath a pedal, inserts the wheel (156) under the level of the bottom of the base (12). The wheel unit (164) on the left has engaged the base (12) but is has not been engaged to lift the base (12) so as to shift the weight of the remotely controlled adjustable flat panel display support system (10) onto the wheel (156). The wheel unit (164) on the right has been engaged and is supporting a portion of the weight of the remotely controlled adjustable flat panel display support system (10) on the wheel (156). The wheel jack mechanism would be held in place by counter tension of one of the articulated joints against the base clamp (166) as shown.

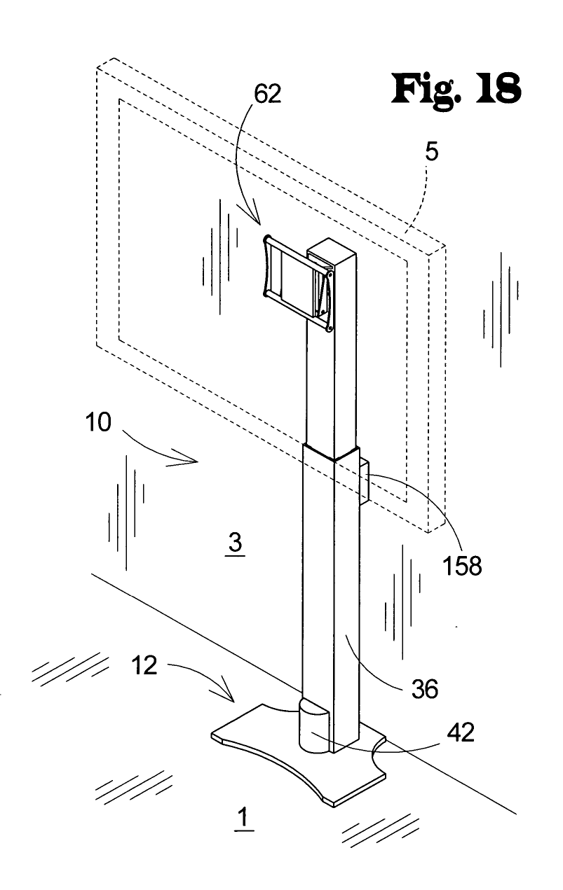

FIG. 18 depicts an embodiment of the remotely controlled adjustable flat panel display support system (10) that includes a wall anchor (158) block that connects from the rear of the foundation column (36) to a nearby wall (3). The form and structure of the wall anchor (158) may take various forms such as a block, beam, set of struts, pyramid and etcetera. Although this embodiment is not free standing the amount of intrusion to a wall would be minimal in comparison to a wall mounted flat panel display devices (5). In this embodiment the size of the base (12) is significantly smaller due to the fact that the base would not have to protect against the toppling of the remotely controlled adjustable flat panel display support system (10) because of the additional stability that the wall anchor (158) provides. The motor (42) of the mast actuator (40) may protrude to the front since the distance between the foundation column (36) and the wall (3) may be minimal.

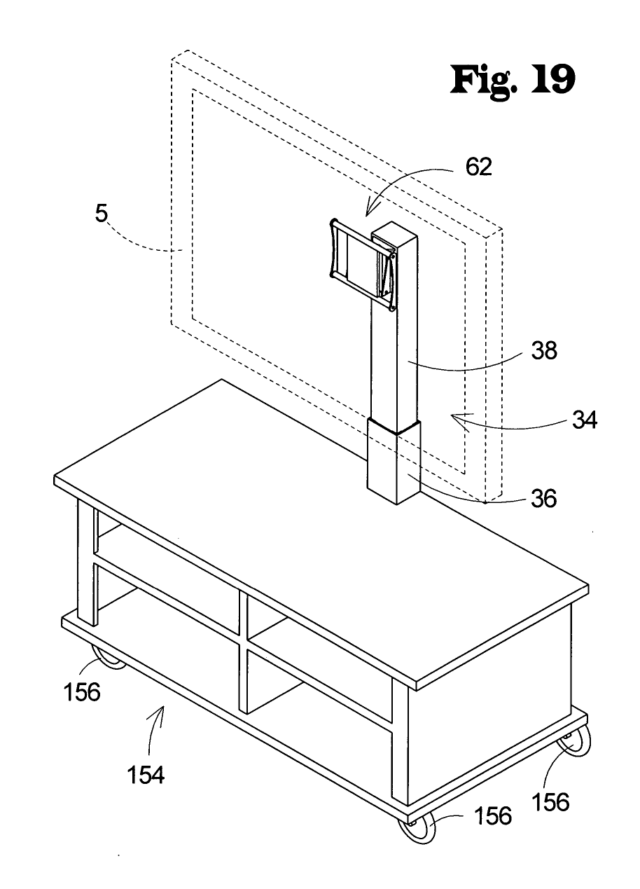

FIG. 19 depicts an embodiment of the remotely controlled adjustable flat panel display support system (10) that includes a console base (154) that may conform to a piece of furniture like a low table, chest of drawers, or traditional television stand. The console base (154) in that it replaces the base (12) in supporting the mast (34) and elements mounted thereon. The console base (154) depicted includes a set of caster type wheels (156) for convenient transfer from location to location. The advantages of the console base (154) in association with a flat panel display device (5) is obvious as a place for storing related devices such as removable media players, satellite tuning systems, video game systems, computers and etcetera.

One of the design considerations for the remotely controlled adjustable flat panel display support system (10) is ease of shipping and assembly. With the remotely controlled adjustable flat panel display support system (10) divided into three major assemblies each piece may be efficiently and effectively packaged, stored and transported via various shipping methods.

The method of assembly may involve setting the base (12) in a location desirous to the user. Base fascia (30) and perimeter trim (28) may then be applied if desired. The mast (34) may be delivered in one piece which would require that the next step to be attaching the mast (34) to the mast flange (24). If the mast (34) was not pre-assembled the steps might include placing the mast actuator (40) on the base (12) with the actuator's foot (44) to the support plate (22). The foundation column (36) might then be attached to the mast flange (24). The extensible column (38) may then be inserted into the foundation column (36) along the low friction guides (50). With the extensible column (38) in its lowest possible position the extension arm (54) may be attached to the telescoping arm (46) of the mast actuator (40) via the ring (48). The extensible column (38) can then be extended out of the foundation column (36) to a level equal to the top end of the extension arm (54) so that the cross bolt (56) may be passed through both the extensible column (38) and the top of the extension arm (54). The orientation assembly (62) may also be pre-assembled wherein the orientation assembly (62) may be mounted to the extensible column (38) by attaching the connector plate (68) to the front side of the extensible column (38) generally near the top or alternately by slipping the cupola (64) over the top of the extensible column (38) or still alternately by coupling the first swivel axel hinge knuckle (70) to the second swivel axel knuckle (86) via the swivel pin (72). The next step in assembly may include attaching the panel bearing struts (120) directly to the flat panel display device (5) via a connector that passes through the mounting slots (124). The flat panel display device (5) along with the attached panel bearing struts (120) may be lifted onto the support rods (118) of the mounting plate (114) via the rod hooks (122) integrated into the panel bearing struts (120). Video, audio control or other signal conductors that the user wanted to couple to the flat panel display device (5) may then be plugged into the base connector port (58) and similar conductors may pass between the top connector port (60) and then into the flat panel display device.

It is to be understood that the above description is intended to be illustrative, and not restrictive. Many other embodiments will be apparent to those skilled in the art upon reviewing the above description. The scope of the invention should, therefore, be determined with reference to the appended claims, along with the full scope of equivalents to which such claims are entitled.

| | |
|---|---|
| 1 | Floor |
| 2 | |
| 3 | Wall |
| 4 | |
| 5 | Flat Panel Display Device |
| 6 | |
| 7 | |
| 8 | |
| 9 | |
| 10 | ADJUSTABLE FLAT PANEL SUPPORT SYSTEM |
| 11 | |
| 12 | Base |
| 13 | |
| 14 | Base Frame |
| 15 | |
| 16 | Front Base Perimeter |
| 17 | |
| 18 | Rear Base Perimeter |
| 19 | |
| 20 | Side Base perimeter |
| 21 | |
| 22 | Support Plate |
| 23 | |
| 24 | Mast Flange |
| 25 | |
| 26 | Slide Pads |
| 27 | |
| 28 | Perimeter Trim |
| 29 | |
| 30 | Base Fascia |
| 31 | |
| 32 | Hitch Connector |
| 33 | |
| 34 | Mast |
| 35 | |
| 36 | Foundation Column |
| 37 | |
| 38 | Extensible Column |
| 39 | |
| 40 | Mast Actuator |
| 41 | |
| 42 | Motor |
| 43 | |
| 44 | Foot |
| 45 | |
| 46 | Telescoping Arm |
| 47 | |
| 48 | Ring |
| 49 | |
| 50 | Low Friction Guide |
| 51 | |
| 52 | Mast Veneer |
| 53 | |
| 54 | Extension Arm |
| 55 | |
| 56 | Cross Bolt |
| 57 | |
| 58 | Base Connector Port |
| 59 | |
| 60 | Top Connector Port |
| 61 | |
| 62 | Orientation Apparatus |
| 63 | |
| 64 | Cupola |
| 65 | |
| 66 | Swivel Hinge |
| 67 | |
| 68 | Connector Plate |
| 69 | |
| 70 | First Swivel Axel Hinge Knuckle |
| 71 | |
| 72 | Swivel Hinge Pin |
| 73 | |
| 74 | Swivel Actuator |
| 75 | |
| 76 | Swivel Bar |
| 77 | |
| 78 | Swivel Articulator |
| 79 | |
| 80 | Swivel Gear |
| 81 | |
| 82 | Swivel Pinion |
| 83 | |
| 84 | Tilt Assembly |
| 85 | |
| 86 | Second Swivel Axel Hinge Knuckle |
| 87 | |
| 88 | First Tilt Axel Hinge Knuckle |
| 89 | |
| 90 | Tilt Hinge Pin |
| 91 | |
| 92 | Tilt Actuator |
| 93 | |
| 94 | Tilt Articulator |
| 95 | |
| 96 | Tilt Connector |
| 97 | |
| 98 | Tilt Plate |
| 99 | |
| 100 | Rotation Assembly |
| 101 | |
| 102 | Rotation Plate |
| 103 | |
| 104 | Axel Plate |
| 105 | |
| 106 | Rotation Axel |
| 107 | |
| 108 | Rotation Actuator |
| 109 | |
| 110 | Rotation Articulator |
| 111 | |
| 112 | Mounting Apparatus |
| 113 | |
| 114 | Mounting Plate |
| 115 | |
| 116 | Second Tilt Axel Hinge Knuckle |
| 117 | |
| 118 | Support Rods |
| 119 | |
| 120 | Panel Bearing Strut |
| 121 | |
| 122 | Rod Hook |
| 123 | |
| 124 | Mounting Slot |
| 125 | |
| 126 | Control System |
| 127 | |
| 128 | Wireless Receiver |
| 129 | |
| 130 | Actuator Control Device |
| 131 | |
| 132 | Remote Control Device |
| 133 | |
| 134 | Manual Adjustment Control |
| 135 | |
| 136 | Power Switch |
| 137 | |
| 138 | Extend Mast Control |
| 139 | |
| 140 | Rentract Mast Control |
| 141 | |
| 142 | Swivel Left Control |
| 143 | |
| 144 | Swivel Right Control |
| 145 | |
| 146 | Tilt Up Control |
| 147 | |
| 148 | Tilt Down Control |
| 149 | |
| 150 | Rotate Clockwise Control |
| 151 | |
| 152 | Rotate Counter-Clockwise Control |
| 153 | |
| 154 | Console Base |
| 155 | |
| 156 | Wheels |
| 157 | |
| 158 | Wall Anchor |
| 159 | |
| 160 | Draw Arm |
| 161 | |
| 162 | Carriage Apparatus |
| 163 | |
| 164 | Wheel Unit |
| 165 | |
| 166 | Base Clamp |
| 167 | |
| 168 | Wheel Jack Mechanism |
| 169 | |
| 170 | |
| 171 | |
| 172 | |
| 173 | |
| 174 | |
| 175 | |
| 176 | |
| 177 | |
| 178 | |
| 179 | |
| 180 | |
| 181 | |
| 182 | |
| 183 | |
| 184 | |
| 185 | |
| 186 | |
| 187 | |
| 188 | |
| 189 | |
| 190 | |
| 191 | |
| 192 | |
| 193 | |
| 194 | |
| 195 | |
| 196 | |
| 197 | |
| 198 | |
| 199 | |
| 200 | |

1. A system for adjustably supporting a flat panel display, the system comprising;
a mounting plate, having a first portion configured to engage a flat panel display
an orientation apparatus, operatively coupled with a second portion of said mounting plate; said orientation apparatus being configured to selectively swivel said mounting plate about a first generally vertical axis and tilt said mounting plate about a second generally horizontal axis that is generally perpendicular to said first axis;
a mast, having opposite first and second end portions; said mast being selectively length adjustable so that said first and second end portions may be selectively moved toward and away from one another; said first end portion of said mast being operatively coupled with said orientation apparatus; and
a base; said base being operatively coupled with the second end portion of said mast.

2. The system of claim 1 wherein said orientation apparatus is configured to selectively rotate said mounting plate about a third generally horizontal axis that is generally perpendicular to said first axis and said second axis.

3. The system of claim 1 wherein said orientation apparatus is comprised of a swivel hinge having first and second swivel axel hinge knuckles, pivotably coupled with one another with a swivel hinge pin to permit said orientation apparatus to selectively swivel said mounting plate about said first generally vertical axis.

4. The system of claim 3 wherein said orientation apparatus is comprised of tilt assembly having first and second tilt hinge knuckles, pivotably coupled with one another with a tilt hinge pin to permit said orientation apparatus to selectively tilt said mounting plate about said second generally horizontal axis.

5. The system of claim 4 wherein said orientation apparatus is configured to selectively rotate said mounting plate about a third generally horizontal axis that is generally perpendicular to said first axis and said second axis.

6. The system of claim 5 wherein said orientation apparatus is comprised of a rotation plate having a rotation axel that operatively, rotatably engages an axel plate, which is operatively coupled with said mounting plate; to permit said orientation apparatus to selectively rotate said mounting plate about said third axis.

7. The system of claim 6 wherein said second tilt hinge knuckles are coupled with said rotation plate.

8. The system of claim 1 wherein said mast is comprised of an elongated foundation column at the second end portion of said mast that is operatively coupled with an elongated extensible column at the first end portion of said mast so that said foundation column and said extensible column may be selectively moved between extended and retracted positions alone lengths of said foundation column and said extensible column.

9. The system of claim 8 wherein said foundation column and extensible column are telescopically coupled with one another.

10. The system of claim 1 further comprising a plurality of wheels that are retractable coupled with said base for facilitating easy transport of the system.

11. The system of claim 1, wherein said base is in the form of a console base having one or more storage areas.

12. The system of claim 9 wherein said mast includes at least one low friction guide between said foundation column and said extensible column for reducing friction between said foundation column and said extensible column.

13. The system of claim 8 wherein said mast is provided with a mast actuator to selectively move said foundation column and extensible column between said extended and retracted positions.

14. The system of claim 13 wherein said mast further provided with an extension arm that couples a distal end portion of said mast actuator with said extensible column.

15. The system of claim 9 wherein said orientation apparatus is coupled with a cupola that is operatively coupled with said extensible column.

16. The system of claim 3 further comprising a swivel actuator operatively coupled with said swivel hinge to selectively swivel said mounting plate about said first generally vertical axis.

17. The system of claim 15 wherein said first swivel axel hinge knuckle is coupled with said extensible column.

18. The system of claim 16 further comprising a swivel articulator that operatively couples said swivel actuator with said swivel hinge to facilitate selective swiveling movement of said mounting plate about said first generally vertical axis.

19. The system of claim 18 wherein said swivel actuator is operatively coupled with an extensible column that forms at least the first end portion of said mast.

20. The system of claim 18 wherein said swivel actuator is operatively coupled with a cupola disposed at the first end portion of said mast.

21. The system of claim 4 further comprising tilt actuator operatively coupled with said tilt assembly via a tilt articulator to selectively tilt said mounting plate about said second generally horizontal axis.

22. The system of claim 21 wherein said tilt actuator is operatively coupled with an extensible column that forms at least the first end portion of said mast.

23. The system of claim 21 wherein said tilt actuator is operatively coupled with a cupola that forms at least the first end portion of said mast.

24. The system of claim 21 wherein said tilt actuator is operatively coupled with said swivel hinge.

25. The system of claim 6 further comprising a rotation actuator and a rotation articulator operatively coupled with said rotation axel to facilitate selective rotation of said mounting plate about said third axis.

26. The system of claim 25 wherein said rotation actuator is operatively coupled with said axel plate.

27. The system of claim 25 wherein said rotation actuator is operatively coupled with said tilt assembly.

28. The system of claim 1 further comprising:
a swivel actuator operatively coupled with said orientation apparatus to selectively swivel said mounting plate about said first generally vertical axis;
a tilt actuator operatively coupled with said orientation apparatus to selectively tilt said mounting plate about said second generally horizontal axis; and
a rotation articulator operatively coupled with said orientation apparatus to selectively rotate said mounting plate about a third generally horizontal axis that is generally perpendicular to said first axis and said second axis.

29. The system of claim 28 further comprising a control system operatively coupled with said swivel actuator, said tilt actuator and said rotation actuator for selective activation of said swivel actuator, said tilt actuator and said rotation actuator to adjust an orientation of said mounting plate with respect to said mast.

30. The system of claim 29 wherein said control system comprises;
at least one wireless receiver;
at least one actuator control device operatively coupled with said at least one wireless receiver and said swivel actuator, said tilt actuator and said rotation actuator; and
a control device, having at least a transmitter capable of wireless transmission of signals to said at least one wireless receiver to selectively adjust said orientation of said mounting plate with respect to said mast.

31. The system of claim 29 wherein said control system is further comprised of a manual adjustment control located on said system and operatively coupled with said swivel actuator, said tilt actuator and said rotation actuator to selectively adjust said orientation of said mounting plate with respect to said mast.

32. The system of claim 29 further comprising a mast actuator coupled with said mast to selectively move the first and second end portions of said mast toward and away from one another; said control system being operatively coupled with said mast actuator for selective movement of said mast between extended and retracted positions.

33. The system of claim 1, wherein a wall anchor is coupled with said mast for selective engagement with a wall positioned adjacent the system.

34. The system of claim 1 further comprising at least one carriage apparatus coupled with said base; said carriage apparatus having one or more wheels and at least one wheel jack mechanism associated with said one or more wheels such that actuation of said wheel jack mechanism extends said one or more wheels to a transport position.
